(19) United States
(12) Patent Application Publication
(10) Pub. No.: US 2014/0126330 A1
(43) Pub. Date: May 8, 2014

(54) COILED TUBING CONDITION MONITORING SYSTEM

(71) Applicant: SCHLUMBERGER TECHNOLOGY CORPORATION, Sugar Land, TX (US)

(72) Inventors: Rod William Shampine, Houston, TX (US); Shunfeng Zheng, Katy, TX (US); Rex Pastrana Burgos, Richmond, TX (US)

(73) Assignee: SCHLUMBERGER TECHNOLOGY CORPORATION, Sugar Land, TX (US)

(21) Appl. No.: 13/672,296

(22) Filed: Nov. 8, 2012

(51) Int. Cl. H04B 11/00

(52) U.S. Cl. CPC H04B 11/00
USPC 367/82

(57) ABSTRACT

A system and techniques for acoustically establishing the onset of an emergent condition relative coiled tubing in a well. The system may include fiber optic line run through the coiled tubing for sake of vibration detection in coiled tubing indicative of buckling, structural defects or other downhole coiled tubing conditions. Thus, application optimization action may be undertaken in a manner that enhances coiled tubing operational efficacy.

### BACKGROUND

Exploring, drilling and completing hydrocarbon and other wells are generally complicated, time consuming and ultimately very expensive endeavors. As such, tremendous emphasis is often placed on well access in the hydrocarbon recovery industry. That is, access to a well at an oilfield for monitoring its condition and maintaining its proper health is of great importance. As described below, such access to the well is often provided by way of coiled tubing or slickline as well as other forms of well access lines.

Well access lines as noted may be configured to deliver interventional or monitoring tools downhole. In the case of coiled tubing and other tubular lines, fluid may also be accommodated through an interior thereof for a host of downhole applications. Coiled tubing is particularly well suited for being driven downhole through a horizontal or tortuous well, to depths of perhaps several thousand feet, by an injector at the surface of the oilfield. Thus, with these characteristics in mind, the coiled tubing will also generally be of sufficient strength and durability to withstand such applications. For example, the coiled tubing may be of alloy steel, stainless steel or other suitable metal or non-metal material.

In spite of being constructed of a relatively heavy metal based material, the coiled tubing is plastically deformed and wound about a drum to form a coiled tubing reel. Thus, the coiled tubing may be manageably delivered to the oilfield for use in a well thereat. More specifically, the tubing may be directed through the well by way of the noted injector equipment at the oilfield surface.

Unfortunately, regardless of the durable construction, the coiled tubing is prone to develop natural wear and defects. For example, repeated plastifying deformation as noted above may lead to wear and cracking. Further, pinhole and other defects may emerge at different locations of the coiled tubing as it is abrasively and forcibly advanced through a tortuous well.

Once more, no matter the degree of durability, the coiled tubing is limited by a maximum overall reach when being advanced through a horizontal well. More specifically, one or more ‘build’ well sections emerges as a tortuous or ‘deviated’ well makes a curved transition from a generally vertical section to a generally horizontal section. Thus, as the coiled tubing encounters the elbow, initial resistance to advancement emerges. This resistance continues in the form of friction for the remaining depth of the well. That is, the frictional resistance continues for however far such a horizontal, and generally terminal, lateral leg extends. Therefore, given ever-extending well depths, it is quite likely that the frictional resistance to the advancing coiled tubing will eventually prevent it from extending all the way to the end of the terminal lateral leg. In this manner, the maximum reach of the coiled tubing may be considered less than the depth of the well.

The inability of the coiled tubing to access the entire depth of the well as noted above places practical limitations on the ability to fully service the well. Thus, efforts to address frictional resistance to advancing coiled tubing in horizontal or lateral leg sections have emerged. Namely, friction reducer fluids are often pumped through the coiled tubing as it begins to traverse horizontal well sections. Therefore, as the coiled tubing begins to bend around the noted build section and starts its journey along a horizontal well section, it does so with a lubricant being available at the interface of its outer surface and the well wall. As a result, helical buckling of the coiled tubing may be delayed, thereby extending coiled tubing reach.

Use of lubricating friction reducer fluid as described above may effectively extend the maximum reach of the coiled tubing as indicated. Unfortunately, it does so at a very significant cost due to the high dollar value of the noted friction reducer. Once more, it is generally the case that the high cost friction reducer fluid is not particularly beneficial throughout the entirety of the lateral leg advancement. That is, it is more likely the case that the friction reducer is of primary benefit at more discrete locations along the lateral leg. For example, the well may be of 25,000 feet with the distance between the elbow and the terminal end of the lateral leg constituting a 10,000 foot depth to the 25,000 foot end of the well. However, it may also be the case that only a discrete well location, from 12,000 feet to 18,000 feet, is actually of significant challenge to coiled tubing advancement. Thus, use of the high dollar friction reducer has been largely wasted when utilized at the other lateral leg sections (between 10,000 feet and 12,000 feet and again between 18,000 feet and 25,000 feet).

In the example above, the majority of the expensive friction reducer has been wasted due to the inability of the operator to determine where to best inject the fluid in real-time. That is, no real-time feedback has been provided such as the emergence of helical buckling as noted above. Therefore, the friction reducer fluid has been unnecessarily delivered throughout the entirety of the advancement of the coiled tubing through the lateral leg. Even setting cost aside, the inefficient use of the reducer fluid may require a relatively blind reapplication, a challenging and time-consuming endeavor in its own right. Once more, this inability to determine other emergent coiled tubing conditions may also impair operations. For example, as also noted above, wear and cracking or pinhole defects may impair the functionality of the coiled tubing. However, without some form of real-time indication of the emergence of such defects, operations proceed until the operator is subsequently alerted of ineffective coiled tubing applications which have already taken place.

### SUMMARY

A method is disclosed for monitoring coiled tubing condition during deployment in a well. The method includes advancing the coiled tubing in the well while detecting an acoustic signal by way of vibrations from the coiled tubing. Thus, changes in the acoustic signal may be monitored over time so as to determine an emergence of the condition.

### BRIEF DESCRIPTION OF THE DRAWINGS

FIG. 1 is an overview of an oilfield whereat an embodiment of a downhole coiled tubing condition monitoring system is employed with coiled tubing in a well.

FIG. 2 is a schematic representation of the coiled tubing condition monitoring system of FIG. 1.

FIG. 3A is a side view of the system of FIG. 1 during a condition of coiled tubing buckling within the well.

FIG. 3B is a graph depicting exemplary acoustic data obtained during the buckling condition depicted in FIG. 3A.

FIG. 4A is a side view of the system of FIG. 1 during a condition of emergent pinhole defect condition at a coiled tubing location within the well.

FIG. 4B is a graph depicting exemplary acoustic data obtained during the defect condition depicted in FIG. 4A.

FIG. 5A is a schematic view of an alternative embodiment of a coiled tubing condition monitoring system.

FIG. 5B is a schematic view of a prior art coiled tubing injector system in contrast to the alternate embodiment of FIG. 5A.

FIG. 6 is a flow-chart summarizing an embodiment of employing a donwnhole coiled tubing condition monitoring system during well deployment.

### DETAILED DESCRIPTION

Embodiments of a coiled tubing condition monitoring system are described with reference to certain coiled tubing applications. More specifically, deviated or extended reach coiled tubing applications which are prone to buckling or pipe collapse within a well are detailed. Additionally, differential pipe sticking, mechanical pipe sticking and/or downhole motor stalling issues may be addressed via techniques detailed herein. However, embodiments of the system may also be employed outside of such extended reach contexts For example, real-time, site-specific monitoring of coiled tubing conditions may be of significant value in non-deviated wells, where advance warning of cracking, pinhole and other defects may be of value even in absence of potential buckling. Regardless, embodiments of a coiled tubing condition monitoring system are detailed which may include a fiber optic line disposed through coiled tubing or other means for sake of real-time acoustic data acquisition relative the coiled tubing.

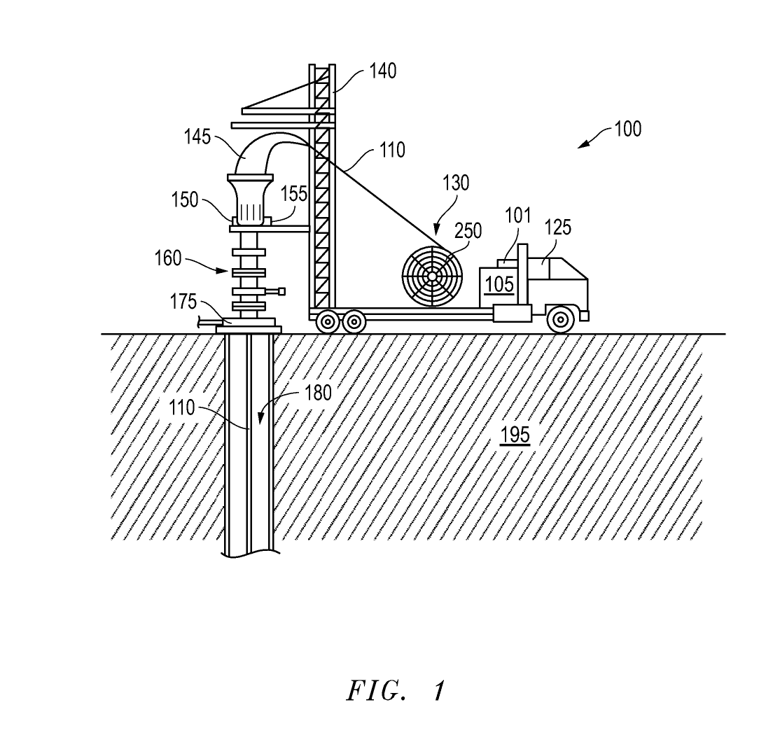

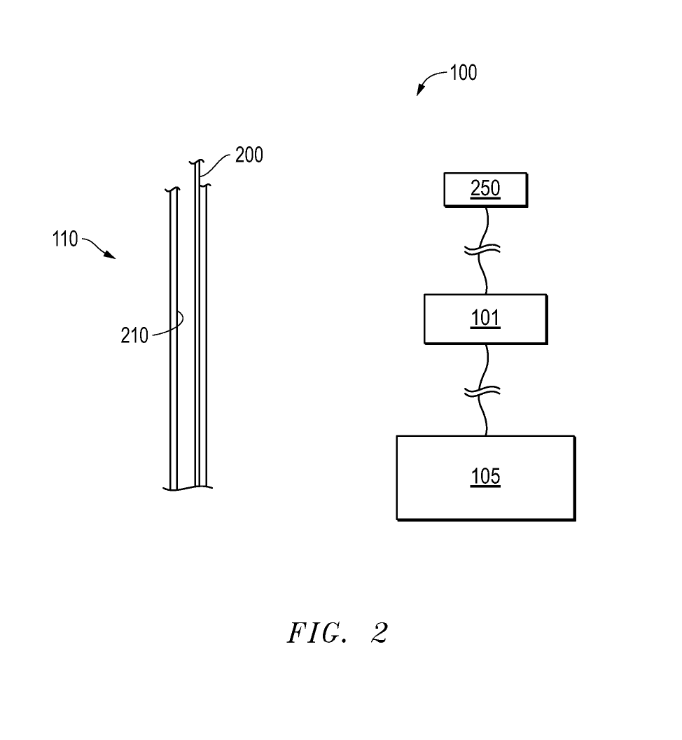

Referring now to FIG. 1, an overview of an oilfield is depicted which accommodates a well 180 having coiled tubing 110 therein for sake of a downhole application. More to the point, however, an embodiment of a downhole coiled tubing condition monitoring system 100 is employed as part of the overall equipment setup at the oilfield surface. Apart from the coiled tubing 110 itself, the system 100 includes an acquisition unit 101. More specifically, this unit 101 is a distributed vibration sensor (DVS) for obtaining fiber optic acoustic data from a receiver 250 at the coiled tubing reel 130. That is to say, the above noted coiled tubing 110 is accommodated at the oilfield by way of a coiled tubing reel 130 and further includes a fiber optic line 200 therethrough for sake of obtaining acoustic data during coiled tubing applications in the well (see FIG. 2). The fiber optic line 200 may be configured to provide electrical power in addition to providing data and/or optical telemetry.

Downhole acoustic data obtained by way of the coiled tubing 110 may be relayed uphole to the receiver 250 at the coiled tubing reel 130 as indicated. The receiver 250 is of a construction tailored to interface the rotatable reel 130 and obtain the noted data therefrom for transmission over to the acquisition unit 101. With the data now available in a usable form at the acquisition unit 101, it may then be obtained and analyzed at a control unit 105. For example, the control unit 105 may include processing capacity and a standard PC interface for an operator at the oilfield. Further, in conjunction with the analysis of acoustic data, or for other purposes, this unit 105 may be utilized in directing and/or altering ongoing downhole applications through the coiled tubing.

Continuing with reference to FIG. 1, the coiled tubing condition monitoring system 100 and reel 130 are delivered to the oilfield by way of a mobile coiled tubing truck 125. Of course, in alternate embodiments other platforms may be employed such as a conventional skid. Regardless, a rig 140 is provided along with a conventional gooseneck injector 145 for forcibly driving the coiled tubing 110 through standard valve and pressure control equipment 160. As such, the tubing 110 may be advanced past the well head 175 and into a well 180 for an application therein.

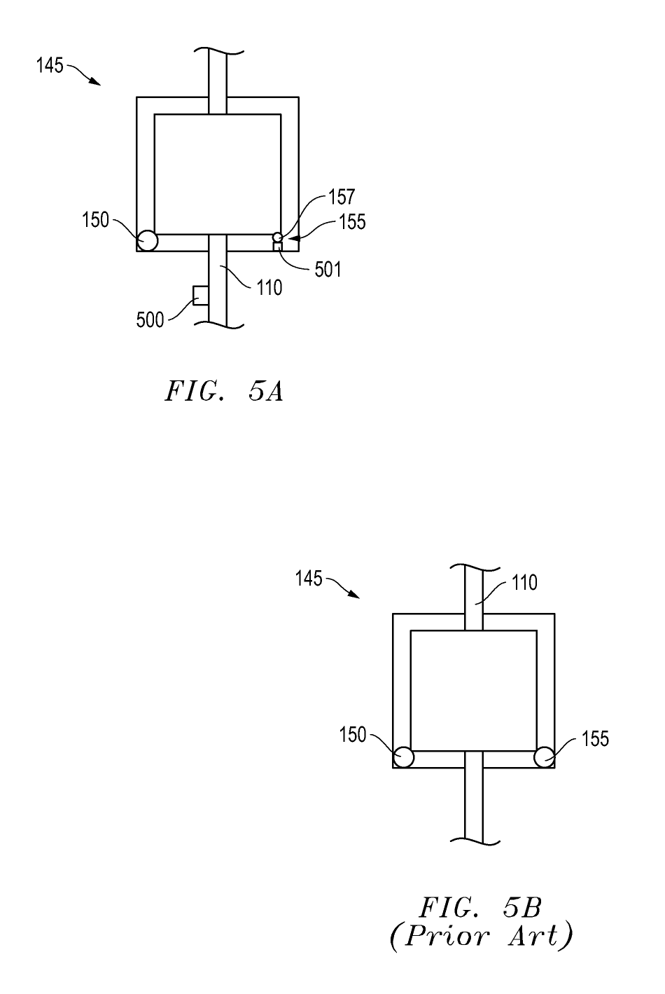

In the embodiment shown, the well 180 initially traverses a formation 195 in a vertical manner. However, as detailed further below, the well 180 may be of fairly extensive reach, eventually traversing the formation horizontally. Thus, as also detailed below, the availability of acoustic data as the coiled tubing 110 is forcibly advanced across such a well path may be of significant advantage. Once more, as detailed with reference to FIGS. 5A and 5B herein, the system 100 may further or alternatively include pivot 150 and load 155 mechanisms to propagate known vibration signals for interpretation during an ongoing application.

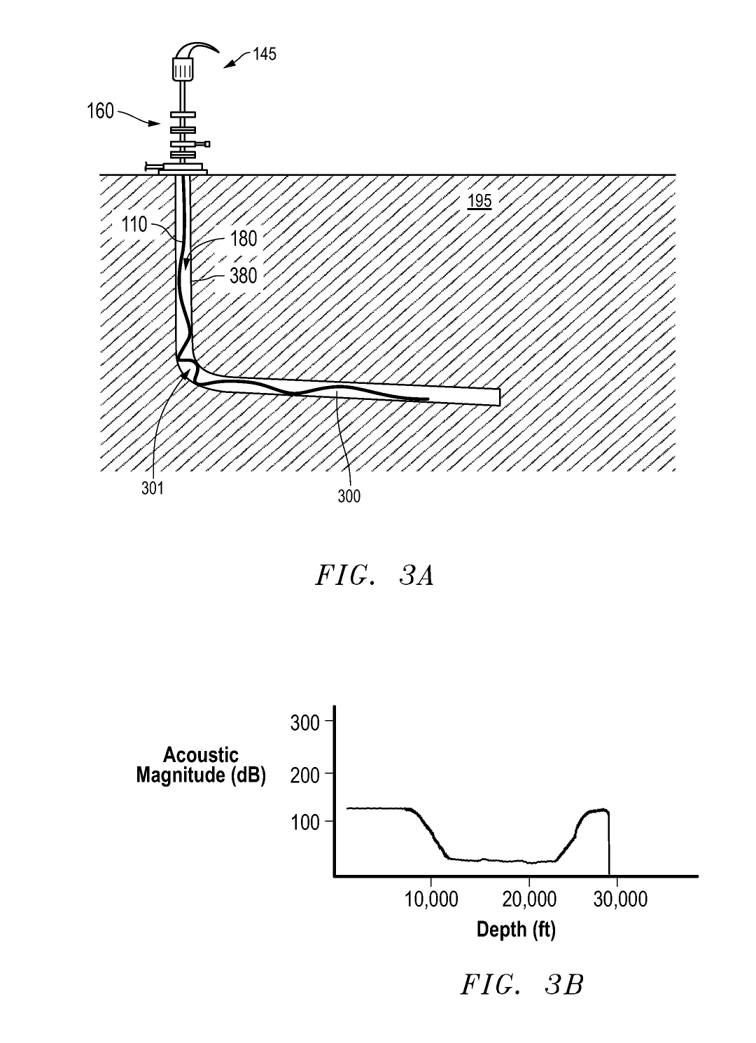

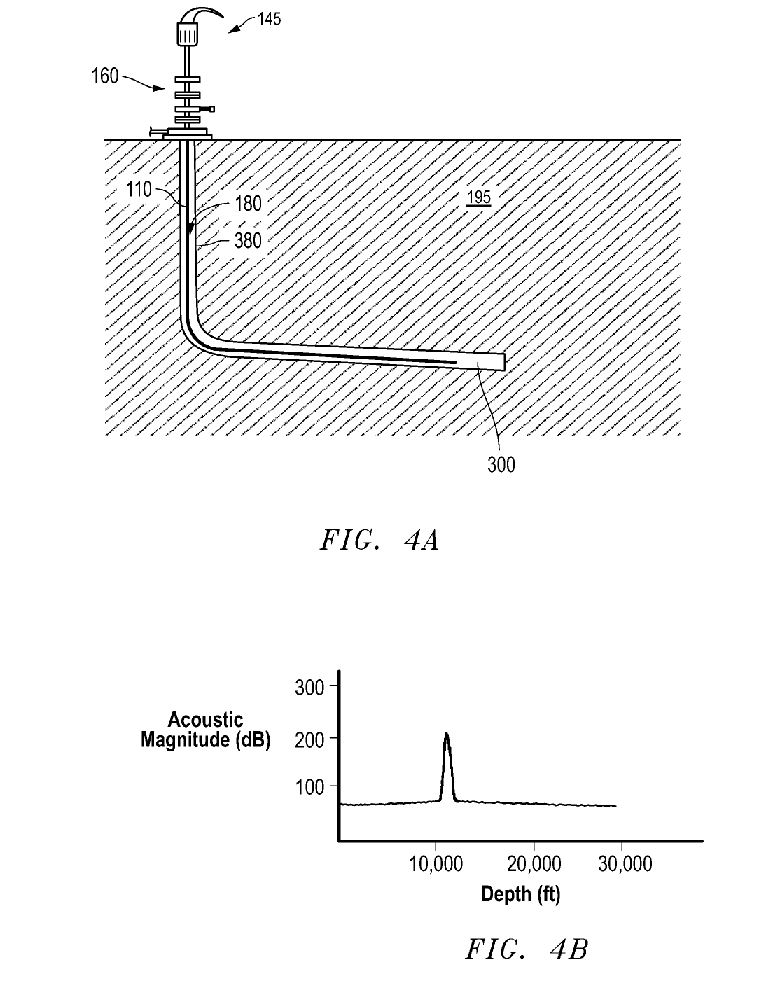

Referring now to FIG. 2, a more schematic representation of the coiled tubing condition monitoring system 100 of FIG. 1 is shown. In this depiction, a fiber optic line 200 is shown adhered to the inner wall 210 of the coiled tubing 110. Thus, acoustic data may be readily obtained therefrom during ongoing downhole coiled tubing operations. In an embodiment, the line 200 may float or otherwise be unrestrained within the coiled tubing 110 as opposed to being adhered to the inner wall 210. Nevertheless, with the tubing 110 advancing through a lateral well section 300 as shown in FIGS. 3A and 4A, contact with the wall 210 and acoustic detection therefrom may ensue. Regardless, as noted hereinabove, the acoustic data may ultimately be obtained by the receiver 250 which interfaces with the reel 130 of FIG. 1.

With the data available, a distributed vibration sensor or other suitable acquisition unit 101 may acquire and store the data in a form suitable for use by a control unit 105. More specifically, distributed vibration measurement data may be site-specifically associated along the length of the coiled tubing 110, section by section. Therefore, the acoustic-based determination of coiled tubing condition may also reveal the particular depth location of the condition of interest. So, for example, a buckling condition may be determined as well as the particular downhole location of the buckling as detailed further hereinbelow.

Continuing with reference to FIGS. 1 and 2, the described system 100 may operate by way of comparative analysis. For example, a baseline acoustic profile of the coiled tubing 110 may be established and stored at the control unit 105. Thus, as acoustically detectable events take place relative the coiled tubing 110, a distinguished interpretation of such events may be deciphered. For example, the emergence of buckling or pinhole defects may be not only be acoustically distinguishable from one another, but also from the acoustic baseline that is the predetermined profile (see FIGS. 3A and 4A). That is, particular decipherable acoustic data signatures may be distinguished at the control unit 105 for follow-on application adjustment or optimization as necessary.

Referring now to FIG. 3A, a side view of the system of FIG. 1 is depicted during a condition of coiled tubing buckling 301 within the well 180. Similarly, a graph depicting exemplary acoustic data obtained during this buckling 301 is depicted in FIG. 3B. As the coiled tubing 110 is advanced downhole, it encounters frictional resistance to continued advancement through the lateral leg 300 of the well 180. This may initially present in the form of sinusoidal buckling in the vertical section 380 of the well 180 which eventually rises to the level of helical buckling 301 as shown at the elbow or heel of the well 180 as it transitions to the lateral section 300. Ultimately, without undertaking supplemental measures beyond the injector 145, this may bring to a halt, the continued advancement of the coiled tubing 110.

The buckling 301 shown in FIG. 3A may be graphically represented via acoustic data as depicted in FIG. 3B. More specifically, the processed data may be displayed to reflect the buckling 301 that begins to emerge at around 10,000 feet of depth and extends to about 25,000 feet of coiled tubing depth. As shown, the acoustic magnitude, noted in Acoustic Magnitude (dB) in the depicted embodiment, markedly decreases as the buckling 301 within the coiled tubing 110 emerges. That is, vibrations which are prevalent throughout the advancing tubing 110, begin to cease as the tubing 110 becomes stuck and immobile due to the buckling 301. This marked decrease of greater than about 10% in distributed vibration (acoustic magnitude) in the exemplary circumstance shown, may be detected by the system 100 of FIG. 2. More specifically, the acoustic data obtained by the fiber optic line 200 of FIG. 2 is tracked over time such that the graph of FIG. 3B may be generated.

Continuing with added reference to FIG. 2, the availability of real-time, site-specific data indicative of downhole buckling, allows an operator at the oilfield surface to employ targeted optimization measures to prevent or overcome such sticking of the coiled tubing 110. For example, the coiled tubing 110 is generally outfitted with a vibration mechanism at its distal end, perhaps in conjunction with an application specific bottom hole assembly. Regardless, with emerging buckling data available, the vibration mechanism may be tailored to turn on, change operating frequency, or otherwise act to prevent or delay buckling, perhaps as soon as sinusoidal buckling begins to emerge. Once more, chemical or mechanical friction reducer may be introduced at targeted locations as the buckling begins to emerge. Thus, the benefits of such reducer may be realized in a more cost-effective and targeted manner as opposed to a more wasteful or blind continuous delivery. In either case, the focused employment of such vibration and/or friction reducer techniques may serve to efficiently extend the overall reach of the coiled tubing 110 and prevent the type of lock-up depicted in FIG. 3A. Indeed, the effectiveness of such measures may be substantially enhanced due to their informed or ‘smart’ application as a result of the available real-time, site-specific data from the system 100.

Measures taken to extend the reach of the coiled tubing 110 into the well 180 may be undertaken upon detection of a circumstance such as the buckling 301 shown in FIG. 3A. Further, the coiled tubing 110 may first be “pulled out of hole” to a degree so as to allow a measure of re-straightening, taking on the appearance depicted in FIG. 4A. That is, even before the full emergence of buckling condition as graphically represented in FIG. 3B, comparison of acquired data with base level acoustic data stored at the control unit 105 may be sufficient for indicating and proactively addressing a forthcoming emergent condition of concern.

Continuing now with specific reference to FIG. 4A, the coiled tubing 110 is shown during a condition of emergent pinhole defect. However, unlike the buckling 301 of FIG. 3A, the pinhole defect is not readily apparent. Further, no particular remedy is immediately available to help alleviate the condition. Nevertheless, advance real-time, site-specific warning may be of significant value.

Referring now to FIG. 4B, a graph depicting an emergent defect condition such as a pinhole defect or cracking is depicted. In the graph, the acoustic data obtained from the line 200 of FIG. 2 remains at a fairly steady level at under about 100 dB in the exemplary embodiment depicted. However, at a coiled tubing location of just over about 10,000 feet of depth, a marked change in acoustic signal (e.g. 10% or higher) would be indicative of the noted defect condition. However, unlike the circumstance of buckling 301, the remedial action available is not in the form of a vibration mechanism or introduction of friction reducer. Rather, the real-time, site-specific warning of the condition allows the operator to halt the application and withdraw the coiled tubing to no more than the location of the condition to ensure the well remains under control. As a result, safety to operators may be ensured and potentially catastrophic issues such as substantial leaking of coiled tubing fluids during an application may be avoided.

Referring now to FIG. 5A, a schematic view of alternate embodiment of coiled tubing condition monitoring platforms is depicted in contrast to a conventional coiled tubing injector system as depicted in FIG. 5B. More specifically, in the embodiment of FIG. 5A, the fiber optic line 200 of FIG. 2 is removed. Instead, the injector 145 is outfitted with a load mechanism 155 that includes a vibration inducer 501. Thus, as detailed further below, an independently located vibration sensor 500 may be utilized in spectrum analysis of return vibrations in the coiled tubing 110 during a downhole application. As such, information indicative of emergent coiled tubing conditions, such as the buckling noted above, may be obtained for sake of operational adjustments. Of course, in other embodiments, surface or downhole coiled tubing tools other than an injector may be utilized in this manner. Additionally, pressure pulse and other techniques may be employed for propagating the sought vibrations.

With brief reference to the comparative depiction of the injector 145 in a conventional form as shown in FIG. 5B, the platform includes an inner frame that interfaces a pivot point 150 and a load mechanism 155. Thus, as the coiled tubing 110 is forcibly advanced through the injector 145, the dynamics of factors such as stress, load, frictional resistance and the like may be tracked on an ongoing basis. However, via the embodiment of FIG. 5A, adjustment to the standard platform may allow vibration techniques to again be utilized to ascertain more specific downhole condition data.

Returning to specific reference to FIG. 5A, the load mechanism 155 is now coupled with a vibration inducer 501 which may be of conventional piezo-based construction. Though, electric, acoustic, or hydraulic inducers may also be utilized. Such sensors may be piezoelectric, electromagnetic, strain gauges, or the like. Regardless, vibrations may be transmitted to the coiled tubing 110 via the injector 145 at a predetermined frequency and amplitude. For example, a wide range of vibrational frequency from 0.1 to 10,000 Hz may be employed. As such, with added reference to FIG. 2, a vibration sensor 500 may be used to collect and relay return data to the acquisition unit 101 of the system 100 for analysis of ongoing coiled tubing conditions during a downhole application. For example, this technique may be useful where the emergence of buckling is of particular concern without any specific regard to downhole location. Further, the sensor 500 may be a conventional vibration sensor or another sensor type, such as a pressure sensor, which may be affected by return vibration in the coiled tubing 110.

In the embodiment of FIG. 5A, the sensor 500 interfaces the coiled tubing 110 at or below the vicinity of the vibrating injector 145. However, in another embodiment, the sensor 500 may be an accelerometer incorporated into a downhole location such as with components of a bottom hole assembly at the distal end of the coiled tubing 110. Thus, vibrational analysis need not account for the degree of dampening and other factors which may affect return vibrations to the sensor 500 when located at the injector 145. Of course, such an embodiment would include telemetric capacity where real-time analysis is sought, for example to address emergent condition of buckling or tubular sticking.

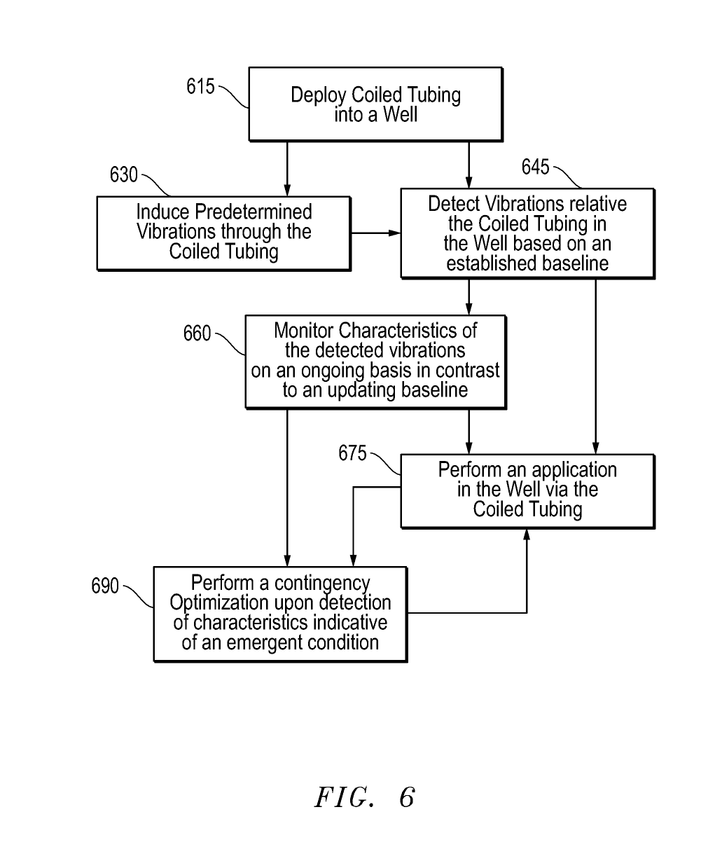

Referring now to FIG. 6, a flow-chart summarizing an embodiment of employing a downhole coiled tubing condition monitoring system is depicted. As noted above, the coiled tubing may be deployed into a well as vibrations are induced on the coiled tubing line (see 615, 630). However, in embodiments here the coiled tubing is equipped with a fiber optic line, as also noted hereinabove, there may be no requirement of a dedicated vibration inducing device in the tubing line. That is, detected vibrations, as indicated at 645, may be site-specific as obtained through the fiber optic line (see 200 of FIG. 2) as a result of normal tubing operation (e.g. pumping, run-in-hole or pull out of hole). Regardless, the overall system is equipped with the capacity to sense or detect vibrations in the coiled tubing line during its deployment in the well. Further, in one embodiment, the detection of vibrations in this manner may encompass recording a baseline of acoustic data, perhaps over the course of coiled tubing operation (e.g. pumping, run-in-hole or pull out of hole). Thus, future analysis indicative of emergent conditions as described below may be ascertained with a greater degree of precision.

Continuing with reference to FIG. 6, the system 100, such as that detailed in reference to FIG. 2 hereinabove, may be employed to monitor characteristics of the detected vibrations on an ongoing basis (see 660). This may even include periods in which downhole applications are performed through the coiled tubing as indicated at 675. However, where these monitored characteristics are indicative of an emergent condition, whether before, during or after such applications, contingency action or optimization may take place as indicated at 690. For example, where characteristics are indicative of an emergent condition of buckling, contingency action in the form of friction reducer delivery, actuating a downhole vibration mechanism, or other measures may be undertaken. Thus, the reach of the coiled tubing may be better maximized.

Embodiments described hereinabove provide for real-time monitoring of coiled tubing conditions during downhole deployment, often in a site-specific manner. As a result, enhanced management of coiled tubing advancement and use in downhole applications may be realized. This may include real-time warning of emergent buckling, sticking, defects and other acoustically detectable conditions. Thus, cost-effective use of contingent actions such as the introduction of a friction reducer or advanced warning of potential compromise to downhole applications may be available to operators.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. For example, a surface pump, injector or other standard operating equipment may serve as the vibration tool without requirement of a dedicated acoustic generating tool. Furthermore, the foregoing description should not be read as pertaining only to the precise structures described and shown in the accompanying drawings, but rather should be read as consistent with and as support for the following claims, which are to have their fullest and fairest scope.

We claim:

1. A method of monitoring a condition of coiled tubing during downhole deployment in a well, the method comprising:
advancing the coiled tubing into the well;
detecting an acoustic signal via vibrations relative the coiled tubing; and
monitoring changes in the acoustic signal over time to determine an emergence of the condition.

2. The method of claim 1 further comprising performing an application in the well via the coiled tubing.

3. The method of claim 1 further comprising establishing a predetermined acoustic profile of the coiled tubing in advance of the determination of the emergent condition.

4. The method of claim 1 further comprising performing a contingency optimization upon the determination of the emergent condition.

5. The method of claim 4 wherein the emergent condition comprises coiled tubing buckling.

6. The method of claim 5 wherein said contingency optimization includes one of operating a vibration mechanism coupled to the coiled tubing in the well and delivering friction reducer through the coiled tubing in the well.

7. The method of claim 1 wherein the emergent condition is a defect condition in the coiled tubing.

8. The method of claim 7 wherein the defect condition in the coiled tubing is one selected from a group consisting of a pinhole defect, cracking, pipe collapse, differential pipe sticking, mechanical pipe sticking and motor stalling.

9. The method of claim 1 wherein said detecting comprises employing a fiber optic line within the coiled tubing for acquisition of the signal.

10. The method of claim 1 further comprising inducing a vibration in the coiled tubing through a vibration tool located at one of an oilfield adjacent the well and a downhole location of the coiled tubing, said detecting comprising acquiring the signal via a sensor interfacing the coiled tubing.

11. A coiled tubing condition monitoring system comprising:
coiled tubing for advancing into a well;
a fiber optic line through said coiled tubing; and
an acoustic data acquisition unit communicatively coupled to said line.

12. The system of claim 11 wherein said acquisition unit comprises a distributed vibration sensor.

13. The system of claim 11 further comprising a control unit coupled to said acquisition unit for deciphering of acoustic signals indicative of an emergent condition in said coiled tubing.

14. The system of claim 13 wherein said fiber optic line is adhered to an inner wall of the coiled tubing to allow the deciphering to be site-specific relative the emergent condition in said coiled tubing.

15. The system of claim 13 wherein said fiber optic line is located through said coiled tubing in an unrestrained manner.

16. The system of claim 15 wherein the deciphering is site-specific relative an emergent condition of buckling of said coiled tubing.

17. A coiled tubing condition monitoring system comprising:
coiled tubing;
an injector for forcibly driving said coiled tubing relative a well;
a vibration inducer coupled to said injector for inducing a predetermined vibration frequency through said coiled tubing; and
a sensor for interfacing said coiled tubing, said sensor for acquisition of an acoustic signal indicative of an emergent condition in the coiled tubing.

18. The system of claim 17 wherein said sensor is selected from a group consisting of a vibration sensor and a pressure sensor.

19. The system of claim 17 wherein said vibration inducer is one of piezo-based, hydraulic, acoustic and electric construction.

20. The system of claim 17 wherein the interfacing is at a location selected from a group consisting of immediately below said injector and at a distal end of said coiled tubing.
